(19) United States
(12) Patent Application Publication
(10) Pub. No.: US 2006/0294168 A1
(43) Pub. Date: Dec. 28, 2006

(54) APPARATUS AND METHOD OF POSTING A SIGN ON A CROSSBAR

(76) Inventors: John R. Scott, San Diego, CA (US); Leonard C. Berman, San Diego, CA (US)

Correspondence Address: THOMAS J. TIGHE & ASSOCIATES, 6265 GREENWICH DRIVE, SUITE 103, SAN DIEGO, CA, 92122, US

(21) Appl. No.: 11/160,418

(22) Filed: Jun. 23, 2005

(51) Int. Cl. G06F 13/00

(52) U.S. Cl. 708/160

(57) ABSTRACT

A sign sleeve includes a hollow cylinder that conformingly fits around a crossbar. Two opposing side flaps can be opened for draping the cylinder over the crossbar and thereafter fastened to close the cylinder. An exposed face of the cylinder bears sign indicia. Preferably the cylinder is formed from a rectangular planar sheet defining creases for folding the sheet into the cylinder. An implement on a pole temporarily interlocks with a sleeve to carry the sleeve up to a remote overhead crossbar and drape it over the crossbar. Preferably the implement further includes a framework for guiding the flaps into a closure disposition and for forcing closure. A method of posting a sign sleeve on a remote overhead crossbar is also disclosed.

### BACKGROUND OF THE INVENTION

This invention relates in general to apparatuses and methods of posting a sign on a crossbar (as defined herein), and in particular to a novel sign-bearing sleeve and a novel apparatus for installing the sleeve on a remote overhead crossbar. As used herein, the term “crossbar” refers to any generally horizontal bar.

While this invention can be used to advantage for posting a sign bearing any kind of message on any crossbar, it is especially useful for posting a sign on a remote overhead crossbar, “remote” meaning that the crossbar is well beyond the reach of a typical person standing on the ground. An example of a remote overhead, crossbar is a crossbar on a utility pole. As used herein “utility pole” refers in general to the ubiquitous vertical spars or frameworks, usually with one or more crossbars, used to support overhead telephone and electrical power lines. This invention is especially useful for posting a sleeve that bears a sign, for example, a “High Voltage” warning, by use of a novel method and a novel implement, onto a crossbar of a high voltage utility pole. As used herein a “sign” is a notice publically displayed for informing the public of something.

As to utility poles, this invention addresses a long-standing safety problem. In the past thousands upon thousands of utility poles carrying high voltages were put in place with no, or inadequate, warnings about the presence of high voltages. As a consequence there have been many injuries and deaths resulting from a lack of such warnings. In response to this growing safety issue, some states, including California, have enacted laws requiring that all such utility poles be retrofitted with signs warning of the presence of high voltages. These signs are generally posted on more than one crossbar so they can be seen from each direction.

Heretofore, the retrofitting of warning signs on a utility pole has required either that a person climb the pole and somehow affix or paint the warning signs while hanging from the pole and while avoiding all lines and terminals carrying high voltages, or the on-site use of a truck with an elevator bucket to lift a person in close proximity to the crossbars while avoiding the high voltages. In either case the person is working in close proximity to high voltages. This invention provides a way for a person to post such warning signs on crossbars either while standing on the ground—no need to climb a pole, or by use of a bucket elevator, but in either case the person is far away from any high voltage lines. Other advantages are that the posting can be done very quickly, reducing man-hours of labor, and the posting requires no fasteners, such as nails, screws or staple guns. Also no painting is required, and no second sign is required on a crossbar because this invention posts signs on both sides of a crossbar. Other advantages and attributes of this invention will be readily discernable upon a reading of the text hereinafter.

### SUMMARY OF THE INVENTION

An object of this invention is to provide a solution to all the problems stated above.

An object of this invention is to provide a solution to all the problems not stated above but for which this invention provides a solution.

An object of this invention is to provide the means and method to enable a person to post a sign on a remote overhead, crossbar without climbing up to the crossbar or being elevated to the crossbar.

A further object of this invention is to provide the means and method to enable a person to post a sign on a crossbar requiring no painting or fasteners such as screw, nails and staples.

An object of this invention is to provide the means and method to enable a person to post a sign on a crossbar of utility pole without climbing up to the crossbar or being elevated to the crossbar.

A further object of this invention is to provide the means and method to enable a person to post a sign on a crossbar of utility pole requiring no painting or fasteners such as screw, nails and staples.

An object of this invention is to provide an all-weather, durable, wind-resistant, ultraviolet ray resistant sign sleeve easily and quickly postable on crossbars.

An object of this invention is to provide an apparatus useable from ground level for posting sign sleeves on crossbars of utility poles.

These objects, and other objects expressed or implied in this document, are accomplished by a sign sleeve for posting on a crossbar of polygonal cross-section, the sleeve including: a hollow cylinder that when closed conformingly fits around a length of the crossbar; two opposing side flaps defined by the cylinder which can be opened for draping the cylinder over said length of the crossbar and thereafter joined to close the cylinder about said length of the crossbar; a mating pair of fasteners on respective margins of the flaps to join the flaps; and an exposed surface of the cylinder bearing sign indicia. Preferably the sign sleeve is formed from a rectangular planar sheet defining a plurality of parallel spaced-apart creases for folding the sheet into the hollow cylinder that conformingly fits around said length of the crossbar. A sign sleeve mounting implement includes a device, connectable to a pole, for interlocking with the sign sleeve to elevate it up to a crossbar and to drape the sign sleeve over the crossbar; and a frame for guiding the flaps into a closure disposition and for forcing the mating pair of fasteners into engagement. Preferably the implement further includes a tongue and a tab slot, and preferably the sign sleeve also includes a socket for engaging the cylinder with the implement's tongue for elevating and supporting the sign sleeve while it is being draped over a crossbar; and a tab projecting from a side of the cylinder for being engaged by the implement's tab slot to hold the cylinder at a proper draping orientation during draping. Preferably the flaps' guide includes a wall, a rail and a tail together forming generally a hook-shaped frame for manipulating the flaps into closure disposition, the rail being used to apply force (pressure or tamping) to the flaps to achieve closure. A method of posting a sign sleeve as described above on a remote overhead crossbar by means of an implement as described above includes the steps: connecting the base to a pole; either before the previous step or afterward, interlocking the sleeve with the apparatus; elevating the sleeve to above the crossbar by manipulation of the pole; lowering the sleeve onto the crossbar with the flaps straddling the crossbar; disconnecting the sleeve and the apparatus; using the guide frame to manipulate the flaps into a closure disposition; and forcibly abutting the frame seat against the flaps until closure is achieved.

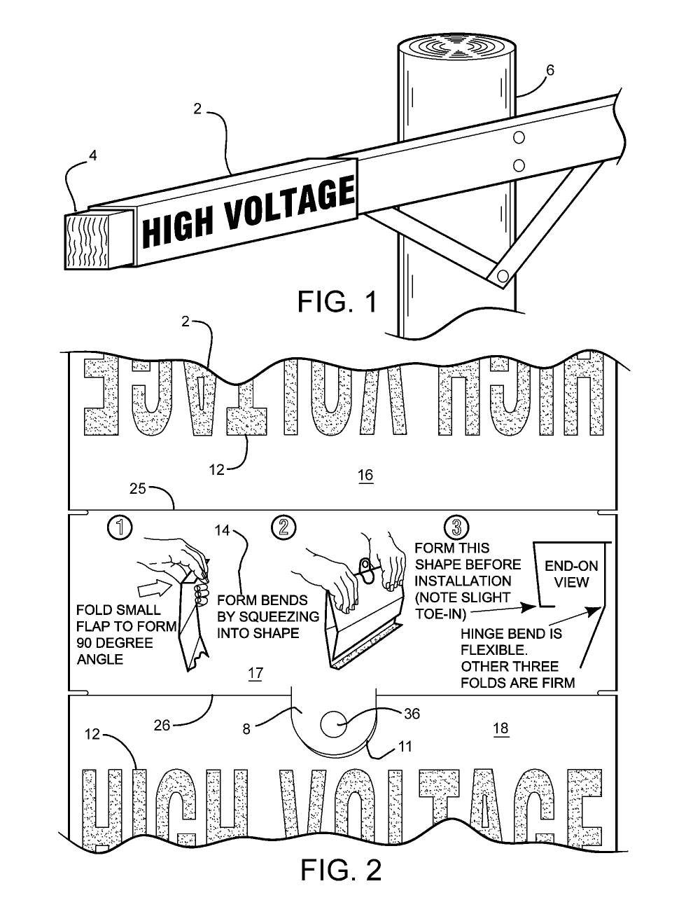

FIG. 1 is a pictorial view of a typical utility pole crossbar bearing a novel sign sleeve according to this invention.

FIG. 2 is a partial plan view of an unmounted sign sleeve according to this invention.

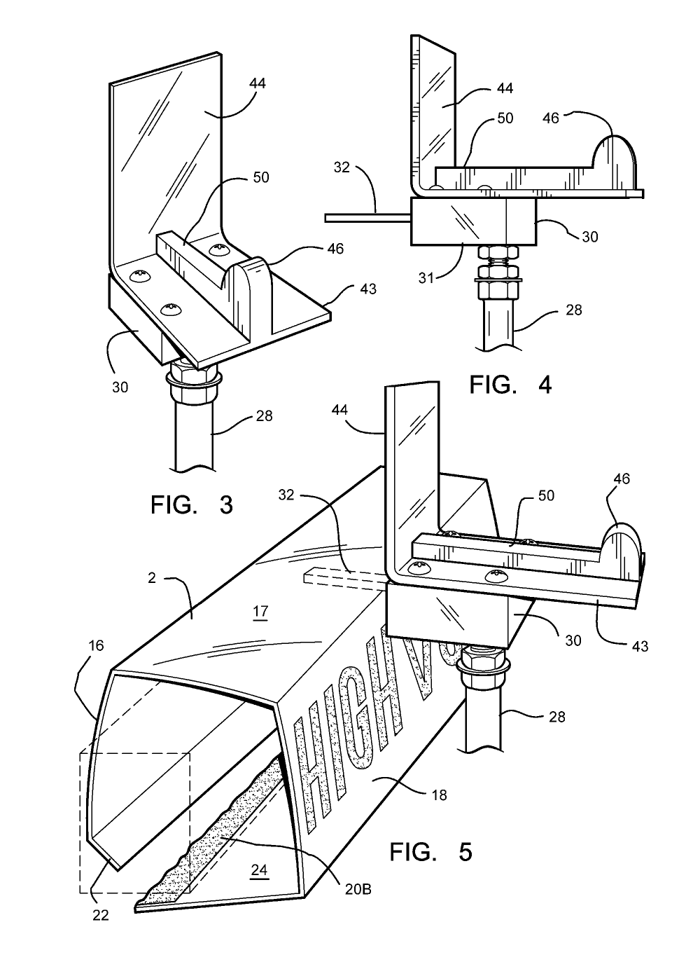

FIG. 3 is a frontal pictorial view of a sign sleeve mounting implement according to this invention.

FIG. 4 is another pictorial view of the sign sleeve mounting implement of FIG. 3 taken from a side.

FIG. 5 is a pictorial view of the sign sleeve mounting implement interlocking with a sign sleeve for mounting it onto a crossbar.

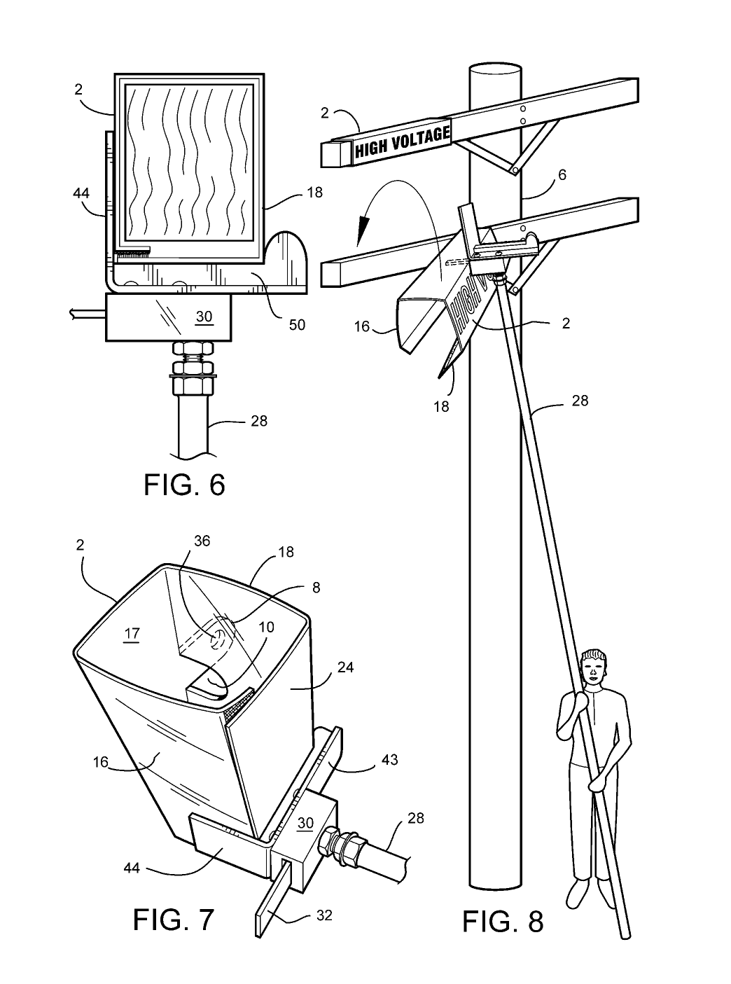

FIG. 6 is a side view of a sign sleeve being mounted, according to this invention, onto a crossbar.

FIG. 7 is a pictorial view illustrating use of the sign sleeve mounting implement for guiding a sign sleeve into closure.

FIG. 8 is a pictorial view of a person mounting a sign sleeve onto a crossbar of a utility pole, according to this invention.

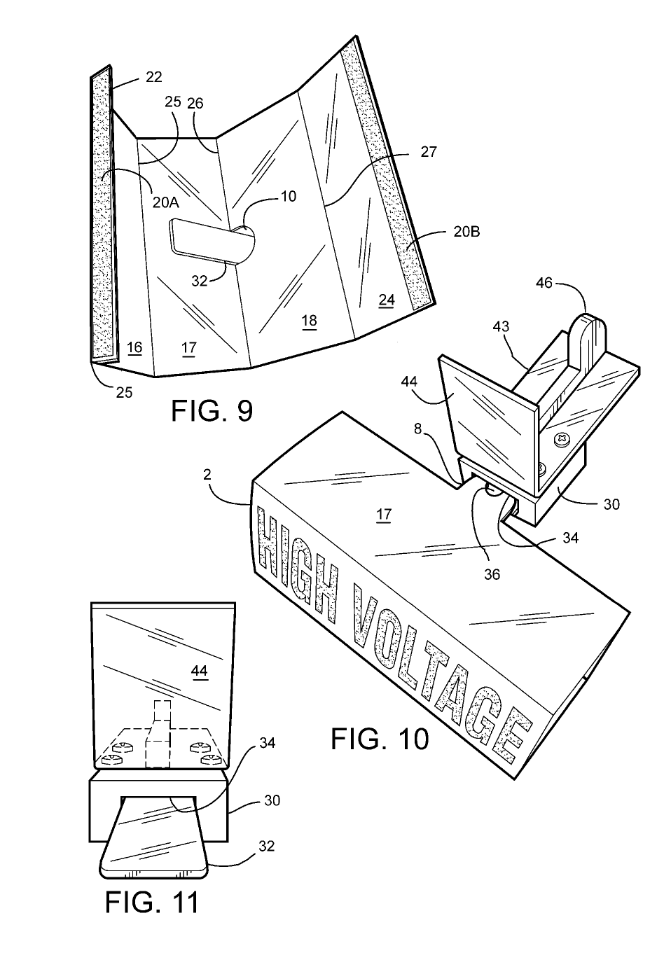

FIGS. 9 and 10 are pictorial views illustrating how the sign sleeve mounting implement engages a sign sleeve for mounting it.

FIG. 11 is a front perspective view of the sign sleeve mounting implement.

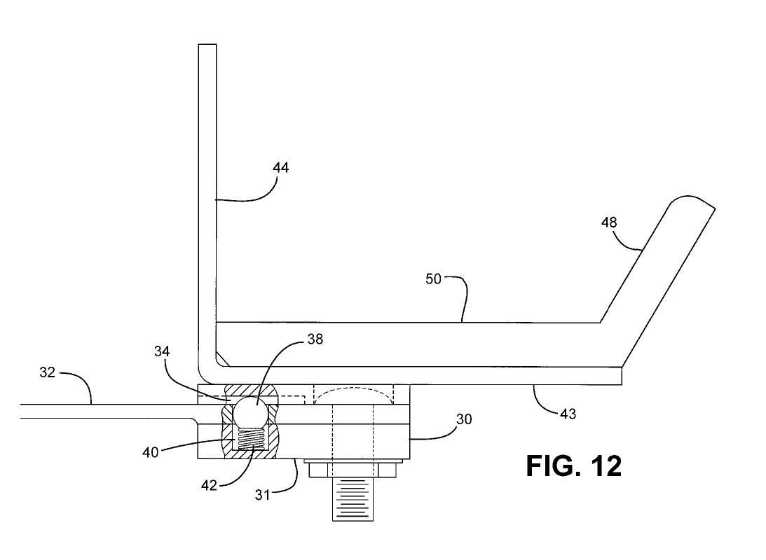

FIG. 12 is a side view with a partial cross-section of an alternative embodiment of the sign sleeve mounting implement.

### DESCRIPTION OF THE PREFERRED EMBODIMENT

Referring to FIGS. 1, 2, 5, and 7-9, a sign sleeve 2 is illustrated to be mounted on a crossbar 4 of a utility pole 6. The sign sleeve includes a hollow cylinder that when closed conformingly fits around a length of the crossbar, a control tab 8, a socket 10 (best shown in FIG. 7), and sign indicia 12 imprinted on one or more outside walls of the cylinder. The functions of the control tab and socket will be explained below. As illustrated a preferred embodiment also includes mounting instruction indicia 14. As illustrated, the crossbar has a rectangular cross-section and the cylinder has a conforming rectangular profile edge-wise, but the sign sleeve of this invention is not limited to crossbars of rectangular cross-section. The conformity of the sleeve to a crossbar's cross-sectional profile is to prevent the sleeve from turning axially on the crossbar, and so this invention encompasses a sign sleeve conforming to a any crossbar having in general a polygonal cross-section. As illustrated, the sleeve includes three serially connected and continuous walls, 16, 17 and 18, and a fourth wall that opens and closes. In general the sign sleeve includes two opposing side flaps defined by the cylinder which can be opened for draping the cylinder over the length of the crossbar and thereafter joined to close the cylinder about the crossbar, and a mating pair of fasteners, 20A and 20B, on respective margins of the flaps to securely join the flaps. It should be understood that the flaps need not comprise just the components of the fourth wall, but can include the walls adjoining the fourth wall components because it is typically necessary to also spread the adjoining walls to facilitate draping a sign sleeve over a crossbar—as best illustrated in FIGS. 5 and 8. Preferably one such flap includes wall 16 and a portion 22 of the fourth wall wide enough to carry fastener 20A, and the other flap is the balance 24 of the fourth wall that includes fastener 20B.

Referring to FIGS. 2, 7 and 9, preferably each sign sleeve cylinder starts as a rectangular planar sheet that defines a plurality of parallel spaced-apart creases, 25, 26 and 27, for folding the sheet into the hollow cylinder that conformingly fits around the length of a target crossbar. Preferably the creases 25 and 26, described above, are stiff enough to hold the walls in optimal relation to each other, as adjusted by a user, for draping over a crossbar, as best illustrated in FIG. 2, except for the crease 27 between the balance 24 of the fourth cylinder wall and its adjoining wall 18, which is preferably much more flexible to allow gravity to swing the fourth wall portion 24 into a sufficiently open position so as to not obstruct the draping. The desired stiffness of the creases is achieved by controlling the depth and the angle of the creases, as explained below. The control tab 8 and tongue socket 10 are preferably created by an oblong semi-circular discontinuity 11 defined by and through the sheet, preferably by stamp cutting. The discontinuity originates and ends at, or slightly beyond, the crease 26 that is the most centrally disposed of the creases in the sheet, and interrupts the crease 26, that is, there is no crease through the area within the discontinuity. When the sheet is folded at the creases to form the cylindrical sleeve, the area within the discontinuity (tab 8) does not fold, but rather protrudes laterally from the sleeve, leaving a hole 10 which serves as a socket for the implements' tongue 32. Preferably the discontinuity is also centrally disposed with respect to the length of the sleeve to place it at or near the sleeve's center of gravity.

Referring to FIGS. 3-12, a sign sleeve mounting implement, according to this invention, is affixed to a pole 28, preferably a telescoping pole, for elevating an open sign sleeve 2 up to a crossbar, for draping the open sleeve over the crossbar, for guiding the open sleeve to a closure disposition, and for pressing the mating pair of fasteners, 20A and 20B, into engagement. The implement includes a base block 30 having an underside 31 that is attachable to an extensible pole 28, “underside” being an arbitrary designation for clarity of description. Projecting from the base block normal to the pole is an elongated tongue 32 that, in operation, is inserted into a sign sleeve's cylinder through socket 10 for catching and carrying the sleeve, as best illustrated in FIGS. 5 and 9. Directly above the tongue (“above” being in a direction away from the pole), the base block defines a control tab slot 34. In operation during a sign sleeve mounting, a user ensures that the sign sleeve's control tab 8 is inserted into the tab slot 34 when the tongue 32 is inserted into the sleeve's socket 10. The control tab projecting from a side of the sign sleeve's cylinder is for being engaged by the implement's tab slot to hold the cylinder at a proper draping orientation during draping. In other words, the tab being confined in the slot prevents the sleeve, during mounting, from pitching, yawing or rolling with respect to the implement's lifting tongue.

Referring to FIG. 12, to further secure the sleeve's control tab 8 within the base block's tab slot 34 during mounting, the base block includes a detent that lodges in a centrally disposed hole 36 defined by the control tab. As illustrated, the detent preferably comprises a sphere 38 disposed in a hole 40 defined by the base block, and biased to intrude into the tab slot 34 by coiled spring 42. The hole 40 is disposed to register the sphere with a control tab hole 36 whenever the tab is operationally within the tab slot. The bias of the detent is strong enough to secure the sleeve in relation to the implement during draping, but it is weak enough to allow disengagement of the implement from the sleeve following completion of the draping. Thus, the sleeve and the implement are temporarily interlocked, for the purposes of lifting and draping, by the combination of the tongue 32 inserted into the sleeve through the tongue socket 10, and the tab 8 inserted into the tab slot 34 and being held in there by the detent.

Referring to FIGS. 3, 4, 6, 7 and 12, as for securely closing a draped sleeve's flaps, the invention includes a generally hook-like frame for guiding the flaps into a closure disposition, and for forcibly closing the flaps. Atop the base block 30 is a preferably planar guide wall 44 that projects angularly away from the base block, generally ninety degrees as illustrated for this embodiment. For clarity of description, the “top” of the base block is the side opposite the block's underside 31. Also affixed to the top of the base block is an elongated frame seat, preferably the flat top of a rail, the plane of the rail top being perpendicular to the line of an attached pole so that axial force applied to the pole can be optimally distributed by the rail to the closable side of the sleeve as described below. Preferably the rail runs squarely away from the guide wall 44 with one end of the rail being proximate a base of the wall, the rail's long axis lying in a plane that bisects the wall. In this embodiment, the rail is affixed atop an elongated support plate 43 affixed to the base block top, the support plate being an angled extension of the wall 44. At an end of the rail distal from the wall is a tail projection 46. Preferably the distance from the wall to the tail projection matches the lateral width of a bottom side of a sign sleeve, the “bottom side” being the closable side of the sleeve that should be facing the ground surface after the sleeve is draped over a crossbar. The guide wall and the tail cooperate to guide the flaps onto the frame seat, i.e., the rail, in a closure disposition, as best illustrated in FIGS. 6 and 7. In one preferred embodiment, the tail projection is rounded to facilitate guidance of the sleeve flaps, as illustrated in FIGS. 3-8. In an alternative embodiment, as illustrated in FIG. 12, the tail is a rail 48 projecting from the base block 30 at an oblique angle. Either embodiment assists a user in capturing a sleeve's side walls, e.g. 16 and 18, between the guide wall 44 and the tail to bring the sleeve into closure disposition, as best illustrated in FIG. 6. The rail top being perpendicular to the pole is used to apply pressure to the mating fasteners, 20A and 20B, as best illustrated in FIGS. 6 an 7, to ensure that they mate securely enough to withstand adverse conditions. The rail structure strengthens the implement and helps to concentrate force applied from below by an installer to the mating fasteners.

A method of posting a sign sleeve on a remote overhead crossbar by use of the implement as described above includes the steps: connecting the base to a pole; either before the previous step or afterward, interlocking the sleeve with the apparatus (implement); elevating the sleeve to above the crossbar by manipulation of the pole; lowering the sleeve onto the crossbar with the flaps straddling the crossbar; disconnecting the apparatus from the sleeve; using a guide frame to manipulate the flaps into a closure disposition; and forcibly abutting the frame seat against the flaps until closure is achieved. Preferably, the interlocking step comprises the step of engaging the lateral socket and the tab of the sleeve with, respectively, a tongue and a tab socket of the apparatus; and the disconnecting step comprises the step of disengaging the tongue and the tab.

Preferably the sign sleeve mounting implement is constructed of lightweight material such as LEXAN with nylon bolts combining the assembled components. Preferably the sign sleeve is made from high density polyethylene (HDPE) and is resistant to the effects of ultraviolet rays from the sun. Preferably the creases are made in the sheet of HDPE using a standard die cutting machine with a modified steel rule die. The edge of the steel rule is obliquely angled on both sides with a blunt ridge, that is, it has a truncated wedge-shaped cross-section. A crease of desired stiffness is made by placing a sign sleeve sheet on a heated platen, and pressing the modified steel rule into the sheet to a depth corresponding to the desired stiffness. The shallower the penetration, the stiffer the crease. This process creates an even hinge crease. Preferably the flap fasteners are mating strips of 3M DUAL LOCK recloseable fasteners that employ interlocking mushroom-shaped stems and are UV and plasticizer resistant. Preferably the stem density is between 170-250 stems per square inch. Since such fasteners require significant force to achieve closure, the guide frame seat is preferably a rail for strengthening and for more concentrated distribution of axial force applied to the pole to the flaps' fastener strips.

The foregoing description and drawings were given for illustrative purposes only, it being understood that the invention is not limited to the embodiments disclosed, but is intended to embrace any and all alternatives, equivalents, modifications and rearrangements of elements falling within the scope of the invention as defined by the following claims.

What is claimed is:

1. A sign sleeve for posting on a crossbar, the sleeve comprising:
a hollow cylinder that when closed conformingly fits around a length of the crossbar;
two opposing side flaps defined by the cylinder which can be opened for draping the cylinder over said length of the crossbar and thereafter joined to close the cylinder about said length of the crossbar;
a mating pair of fasteners on respective margins of the flaps to join the flaps; and
an exposed surface of the cylinder bearing sign indicia.

2. The sign sleeve according to claim 1 further comprising:
a rectangular planar sheet; and
the sheet defining a plurality of parallel spaced-apart creases for folding the sheet into the hollow cylinder that conformingly fits around said length of the crossbar.

3. The sign sleeve according to claim 2 wherein each crease has a selected stiffness to facilitate the draping of it over a crossbar.

4. The sign sleeve according to claim 1 wherein the sleeve is made from ultraviolet ray resistant, high density polyethylene.

5. The sign sleeve according to claim 1 wherein the pair of fasteners comprise strips, affixed to respective flaps, of interlockable mushroom-shaped stems.

6. A sign sleeve for posting on a vertically remote crossbar by use of an elevating implement having a tongue and a tab slot, the sleeve comprising:
a hollow cylinder that when closed conformingly fits around a length of the crossbar;
two opposing side flaps defined by the cylinder which can be opened for draping the cylinder over said length of the crossbar and thereafter joined to close the cylinder about said length of the crossbar;
a mating pair of fasteners on respective margins of the flaps to join the flaps;
an exposed surface of the cylinder bearing sign indicia;
a socket for engaging the cylinder with the implement's tongue for elevating and supporting the sign sleeve while it is being draped over a crossbar; and
a tab projecting from a side of the cylinder for being engaged by the implement's tab slot to hold the cylinder at a proper draping orientation during draping.

7. The sign sleeve according to claim 6 further comprising:
a rectangular planar sheet; and
the sheet defining a plurality of parallel spaced-apart creases for folding the sheet into the hollow cylinder that conformingly fits around said length of the crossbar.

8. The sign sleeve according to claim 7 wherein each crease has a selected stiffness to facilitate the draping of it over a crossbar.

9. The sign sleeve according to claim 6 wherein the sleeve is made from ultraviolet ray resistant, high density polyethylene.

10. The sign sleeve according to claim 6 wherein the pair of fasteners comprise strips, affixed to respective flaps, of interlockable mushroom-shaped stems.

11. For a sign sleeve as described in claim 6, an apparatus for draping the sign sleeve over a vertically remote overhead crossbar by use of a pole, the apparatus comprising:
a base including an underside connectable to a pole;
a tongue for engaging the sleeve through the socket for supporting the sign sleeve during elevation of the sign sleeve to the crossbar and during draping; and
a tab slot for engaging sleeve's tab for holding the sleeve at a proper orientation during draping.

12. For a sign sleeve as described in claim 6, an apparatus for posting the sign sleeve on a vertically remote overhead crossbar by use of a pole, the apparatus comprising:
a carrying device, connectable to the pole, for engaging the sign sleeve to carry it up to said crossbar and for draping the sign sleeve over the crossbar; and
a guide, connectable to the pole through the carrying device, for manipulating the flaps into a closure disposition and for forcing closure of the flaps.

13. The apparatus according to claim 12 wherein the carrying device comprises:
a base including an underside connectable to a pole;
a tongue for engaging the sleeve through the socket for supporting the sleeve during elevation of the sleeve to the crossbar and during draping; and
a tab slot for engaging the sleeve's tab for holding the sleeve at a proper orientation during draping.

14. The apparatus according to claim 12 further comprising a guide wall projecting upwardly from the carrying device, a guide tail projecting upwardly from the carrying device and spaced a distance from the wall, the distance at least matching a lateral width of a bottom side of the sign sleeve, and a frame seat atop the carrying device and extending between the wall and the tail, the length of the seat being normal to a line of the pole when connected.

15. The apparatus according to claim 13 further comprising a guide wall projecting upwardly from the carrying device, a guide tail projecting upwardly from the carrying device and spaced a distance from the wall, the distance at least matching a lateral width of a bottom side of the sign sleeve, and a frame seat atop the carrying device and extending between the wall and the tail, the length of the seat being normal to a line of the pole when connected.

16. The apparatus according to claim 14 wherein the frame seat further comprises a rail for concentrating closure force applied by a user through the pole.

17. The apparatus according to claim 15 wherein the frame seat further comprises a rail for concentrating closure force applied by a user through the pole.

18. A method of posting a sign sleeve as described in claim 6 on a remote overhead crossbar by means of an apparatus as described in claim 14, the method comprising the steps:
connecting the base to a pole;
either before step (a) or afterward, interlocking the sleeve with the apparatus;
elevating the sleeve to above the crossbar by manipulation of the pole;
lowering the sleeve onto the crossbar, the flaps straddling the crossbar;
disconnecting the apparatus from the sleeve;
using the apparatus to manipulate the flaps into a closure disposition; and
forcibly abutting the frame seat against the flaps until closure is achieved.

19. The method according to claim 18 wherein the interlocking step comprises the step of engaging the socket and the tab of the sleeve with, respectively, a tongue and a tab socket of the apparatus; and the disconnecting step comprises the step of disengaging the tongue and the tab from the sleeve.
